(19) United States
(12) Patent Application Publication
(10) Pub. No.: US 2010/0163339 A1
(43) Pub. Date: Jul. 1, 2010

(54) FIRE ESCAPE APPARATUS FOR BUILDING

(76) Inventor: Yong-seob Han, Guri-si Gyeonggi-do (KR)

Correspondence Address: IPLA P.A., 3550 WILSHIRE BLVD., 17TH FLOOR, LOS ANGELES, CA, 90010, US

(21) Appl. No.: 12/663,957

(22) PCT Filed: Jun. 10, 2008
(86) PCT No.: PCT/KR2008/003216

§ 371 Date: Dec. 10, 2009

(30) Foreign Application Priority Data
Jun. 12, 2007 (KR) 10-2007-0057399

(51) Int. Cl. A62B 1/02; G06F 7/00

(52) U.S. Cl. 182/18; 182/131; 182/19

(57) ABSTRACT

A fire escape apparatus for a building is provided. The fire escape apparatus comprises: a plurality of guide rails (110) for horizontal movement provided at certain inter-floor intervals on an outer wall (100) of the building; bases (130) coupled to the guide rails for horizontal movement to move therealong through a drive of synchronously driven motors (132) for horizontal movement; a plurality of vertical support stages (120) vertically coupled to each other, and each having a guide rail (140) for vertical movement provided under the base; and a carrier (170) accommodating fire-refugees therein and moving up and down along the guide rails for vertical movement with a lifting device (160), by which upon fire occurrence in multi-storied gathering buildings, people in the building rapidly get away from the inside to outside of the building, and safely and easily escape to the ground, the carrier is automatically moved to a place of the fire occurrence, and upon flame occurrence near the carrier, the flames are extinguished through means for extinguishing the flames, so that people in the building rapidly and safely escape from the building.

### TECHNICAL FIELD

The present invention relates to a fire escape apparatus for a building, and more particularly to a fire escape apparatus for a building by which upon fire occurrence in multi-storied gathering buildings, especially such as high-rise apartments, officetels, schools, hospitals, high-rise buildings, etc., people in the building can rapidly get away from the inside to outside of the building, and safely and easily escape to the ground.

### BACKGROUND ART

In general, when isolated on the high floor upon the fire occurrence in high-rise gathering buildings such as high-rise apartments, officetels, schools, high-rise buildings, etc., people become choked with smoke as well as hardly find an emergency exit or an emergency stair due to fire and smoke, so that the people hardly escape through the emergency exit or emergency stair and hardly secure the escape path.

In this case, for an escape out of the building, in general, the rescue is performed by a rescue ladder or a descending device, a fire department, a helicopter, etc. However, it takes so many times for the fire department or the helicopter to arrive at a place where a fire occurs and rescue the people, so that it is in practice difficult to rescue all the people. Particularly on the high floor, the rescue ladder does not reach the place, making the rescue difficult, and even using the descending device, in the emergency state, the sick and the aged or even ordinary people is beset with difficulties to use it. Further, although it may be considered various methods to use a thing corresponding to a stretcher while being hung from a place of fire occurrence, to use a rope and a hook, or others, these methods have a problem of having difficulties to rescue all people at one time. Furthermore, in case of the rescue using the helicopter, it has a defect in rescuing when the strong winds are blowing, or at night.

In view of the above problems, diverse types of fire escape apparatuses have been proposed.

For instance, Korean Registered Utility Model No. 357390 proposed a fire escape apparatus which is provided in the respective porches on each floor of a high-rise apartment or a store such that people escape from the building, getting on a gondola, by descending the gondola.

However, such a fire escape apparatus has problems in that it cannot adapted to a building having no porch, and that it should be installed on each floor of the building. Furthermore, in the process of descending, if the gondola becomes wrapped with flames, the people hardly escape from the fire.

### DISCLOSURE OF INVENTION

### Technical Problem

Accordingly, the present invention has been made to solve the above-mentioned problems occurring in the prior art, and the present invention provides a fire escape apparatus for a building by which upon fire occurrence in multi-storied gathering buildings, people in the building can rapidly get away from the inside to outside of the building, and safely and easily escape to the ground.

Another object of the present invention is to provide a fire escape apparatus for a building in which upon fire occurrence, a carrier is automatically moved to a place of the fire occurrence and which includes means for, upon flame occurrence near the carrier, extinguishing the flames, so that people in the building can rapidly and safely escape from the building.

### Technical Solution

In accordance with an aspect of the present invention, there is provided a fire escape apparatus for a building comprising: a plurality of guide rails for horizontal movement provided at certain inter-floor intervals on an outer wall of the building; a plurality of vertical support stages vertically coupled to each other, and each having a base coupled to the guide rail for horizontal movement to move therealong through a drive of a synchronously driven motor for horizontal movement, and a guide rail for vertical movement provided under the base; and a carrier accommodating fire-refugees therein and moving up and down along the guide rails for vertical movement with a lifting device.

In an embodiment of the present invention, the lifting device includes a winch provided on an utmost vertical support stage of the vertical support stages, a wire rope wound and unwound with the operation of the winch and connected at its lower end to an upper portion of the carrier, and a plurality of guide rollers provided on the side face of the carrier to roll along the guide rails for vertical movement.

In an embodiment of the present invention, the carrier is provided with a control unit configured to, upon receiving a signal from a fire detecting sensor detecting heat and smoke, drive the motors for horizontal movement and the winch to enable the carrier to automatically move to a place of fire occurrence, or to manually control the carrier.

In an embodiment of the present invention, the carrier is further provided with alarming means operated through the control unit upon the fire occurrence.

In an embodiment of the present invention, the carrier is provided with a door openable by a cylinder device and provided with steps further having a guide lamp.

In an embodiment of the present invention, the carrier is further provided with fire-extinguishing means for extinguishing flames. The fire-extinguishing means may be a fire-extinguisher or a sprayer.

In an embodiment of the present invention, the carrier is preferably provided therein with an oxygen mask.

In an embodiment of the present invention, the carrier is further provided therein with a monitoring camera and a remote controller for allowing a rescuer to remotely control the carrier from outside using images obtained from the monitoring camera.

In an embodiment of the present invention, a lowermost vertical support stage of the vertical support stages is further provided with a storage battery for upon power failure, supplying power to a driving device.

In an embodiment of the present invention, the guide rail for vertical movement has a transverse section of a triangle or a rectangle.

In an embodiment of the present invention, the apparatus is further provided with a telescopic cylinder device for allowing the vertical support stages on the corner of the building to be pivoted from one outer wall to the other outer wall on the corner, the cylinder device having opposite ends wherein one end is connected to the corner side of the building and the other end to the base of the utmost vertical support stage.

### Advantageous Effects

As set forth before, according to the fire escape apparatus for a building of the present invention, at the start of fire occurrence, the carrier 170 can automatically or manually approach the rescuing position so that it is easy to rescue, and it is easy for a rescuer to approach the place of fire occurrence and easily carry out initial fire-fighting using the fire extinguishing means equipped in the carrier 170, thereby considerably reducing economical damage and loss of lives due to fire occurrence.

Further, the fact of fire occurrence can be initially notified to the occupants via the alarming means 220 to allow them to escape rapidly, thereby more effectively reducing loss of lives.

Furthermore, the carrier 170 can be moved to a certain position on the outer wall 100 on the corner of the building, thereby reducing the installing costs of the fire escape apparatus without a need to install many fire escape apparatuses.

### BRIEF DESCRIPTION OF THE DRAWINGS

FIG. 1 is an exploded perspective view illustrating a fire escape apparatus for a building according to an embodiment of the present invention;

FIG. 2 is a perspective view illustrating a fire escape apparatus for a building according to an embodiment of the present invention;

FIG. 3 is a perspective view illustrating a fire escape apparatus for a building having a structure capable of being pivoted about a corner of the building according to the present invention;

FIG. 4A is a sectional view illustrating a major portion of a fire escape apparatus for a building according to an embodiment of the present invention;

FIG. 4B is a sectional view illustrating a major portion of a fire escape apparatus for a building according to another embodiment of the present invention; and

FIG. 5 is a block diagram illustrating a procedure of controlling the operation of a fire escape apparatus for a building according to an embodiment of the present invention.

### BEST MODE FOR CARRYING OUT THE INVENTION

Hereinafter, an exemplary embodiment of the present invention will be described with reference to the accompanying drawings. In the following description and drawings, the terms or the words used in the present description and claims are properly defined and introduced by the inventor in order for the inventor to describe the present invention in a best mode, so that they should be construed as the meanings and concepts corresponding to the technical spirits of the present invention.

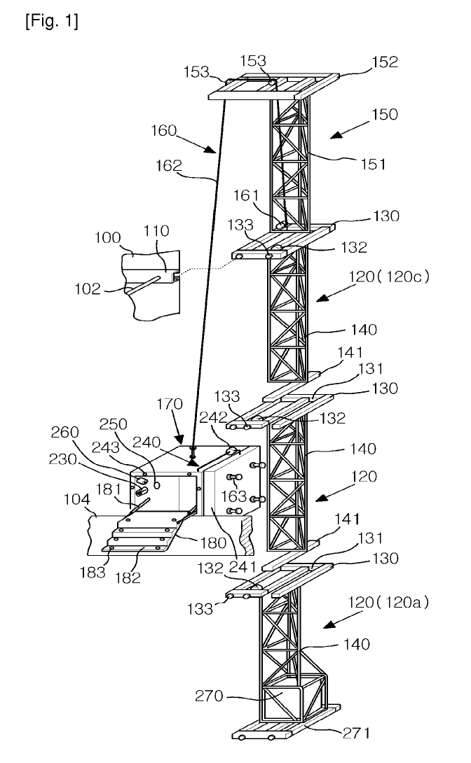

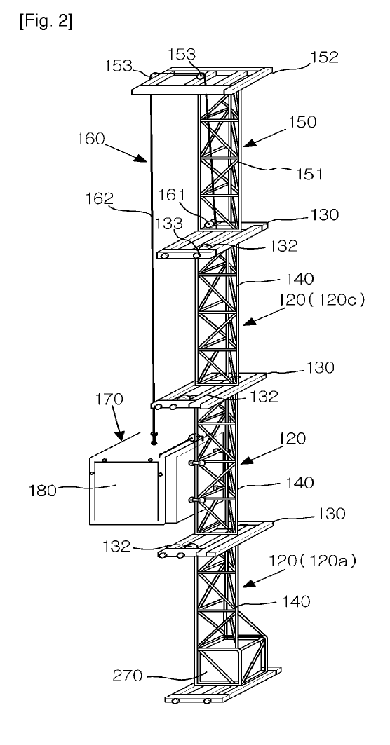

FIGS. 1 and 2 illustrate a fire escape apparatus for a building according to an embodiment of the present invention.

The fire escape apparatus for a building includes a plurality of guide rails 110 for horizontal movement, a plurality of vertical support stages 120, and a carrier 170.

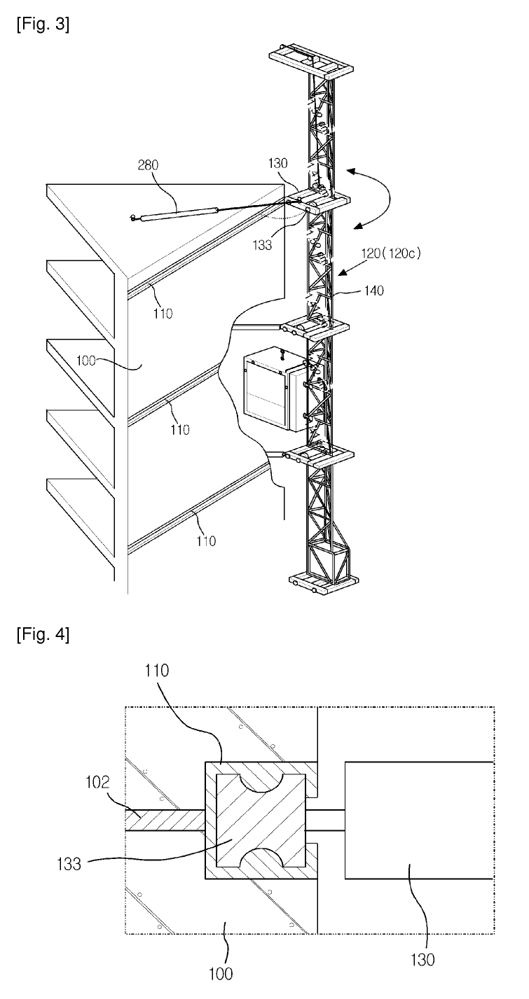

The guide rails 110 for horizontal movement are provided on an outer wall 100 of the building at certain inter-floor intervals, e.g., every second (see FIG. 3), third, or fourth floor, preferably. The guide rails 110 for horizontal movement may be installed so as to be embedded into or protrude from the outer wall 110 of the building such that they are fixed to a concrete reinforcing bar 102 by welding, etc.

Further, as the guide rails 110 for horizontal movement, for example, diverse hollow pipes cut along one faces thereof, a standard rail, or others can be adapted. FIG. 4A illustrates an exemplary guide rail 110 for horizontal movement in which a rectangular hollow pipe cut along one face thereof is provided. Herein, the cut opening of the guide rail 110 for horizontal movement has to direct the outside of the building.

The vertical support stages 120 are vertically provided on the guide rails 110 for horizontal movement with the same number of the guide rails 110 for horizontal movement such that the support stages horizontally move along the guide rails 110 for horizontal movement. The support stages each include a base 130 and a guide rail 140 for vertical movement.

The base 130 may be formed with a horizontal steel frame structure, and the guide rail 140 for vertical movement with a vertical steel frame structure in truss type. Herein, the guide rail 140 for vertical movement may be provided under the base 130. In order to vertically assemble the vertical support stages 120 in series, the base 130 may be provided with a fastening hole 131, and the guide rail 140 for vertical movement may be provided thereunder with a fastening beam 141 fastened in the fastening hole 131.

Then, by assembling the fastening beams 141 of the guide rails 140 for vertical movement into the fastening holes 131 of the bases 130 in series, as illustrated in FIG. 2, the vertical support stages 120 can be vertically assembled in straight with each other.

In addition, on an utmost vertical support stage 120c of the vertical support stages 120, an auxiliary vertical support stage 150 may be provided. The auxiliary vertical support stage 150 may include an auxiliary guide rail 151 for vertical movement connected, at its lower end, to the base 130 of the utmost vertical support stage 120c, and an auxiliary base 152 provided on the guide rail 151 for vertical movement.

The guide rails 140 for vertical movement and the auxiliary guide rail 151 for vertical movement may have a triangular or rectangular section in plan view. Herein, the present embodiment adopts the triangular section.

To move the vertical support stages 120 along the guide rails 110 for horizontal movement while supporting the vertical support stages, the respective bases 130 are provided with a motor 132 for horizontal movement and, on one side thereof, a plurality of driving rollers 133 as illustrated in FIG. 3, inserted into the guide rails 110 for horizontal movement to rotate with a drive of the motor 132. The motors 132 for horizontal movement are preferably driven synchronously.

Thus, with the synchronous driving of the motors 132, the driving rollers 133 of the respective bases 130 rotate in the respective guide rails 110 for horizontal movement, so that the vertical support stages 120 can move horizontally, standing straight.

Further, another type of guide rails 110 for horizontal movement can be adapted as illustrated in FIG. 4B. Such a guide rail 110 for horizontal movement may be comprised of for example, a fixed rail rod fixed to the concrete reinforcing bar 102. Then, when the base 130 is provided, at its end, with a maglev rail 134, wherein it is formed with a hollow pipe cut along one face thereof and engagingly surrounds the guide rail 110 in type of fixed rail rod so that it moves along the guide rail 110 for horizontal movement with magnetic levitation, as set forth above, the vertical support stages 120 can move horizontally, standing straight. In this case, driving means for magnetic levitation is adapted instead of the motors 132 for horizontal movement.

Meanwhile, the carrier 170 is constructed such that upon fire occurrence, fire-refugees in the building move toward the side of the outer wall 100 of the building, and get on the carrier to move to the ground for escape from fire. The carrier 170 is configured so as to be vertically moved along the guide rails 140 for vertical movement by a lifting device 160.

The carrier 170 may be shaped like a rectangular box, for example, and include a door 180 that is hinged to one portion so that it is openable downward with the operation of a cylinder device 181. The door 180 may be configured to be controlled such that when the carrier 170 arrives at a place of fire occurrence (i.e., a place for rescuing fire-refugees), it is automatically opened, it is manually controlled using a control unit 190 to be described later from the inside of the carrier 170, or otherwise, it is remotely controlled using a remote controller 200 to be described later from outside.

Thus, when opened, the door 180 comes to be put over a handrail 104 of a veranda or a window threshold of a building (see FIG. 1), so that the fire-refugees having moved toward the outer wall 100 of the building can get inside the carrier 170 through the door 180.

Further, for convenience in getting on the carrier, the door 180 is preferably provided, on its inside face (i.e., the upper face of the door 180 upon opening), with steps 182.

Furthermore, in the case that it is not easy to secure visibility due to smoke or darkness at night, the steps 182 are preferably further provided with a guide lamp 183 in order to guide the fire-refugees to get on the carrier.

As set forth before, the carrier 170 is moved up and down along the guide rails 140 for vertical movement by the lifting device 160. The lifting device 160 may include a winch 161, a wire rope 162, and a plurality of guide rollers 163. The winch 161 may be provided on the base 130 of the utmost vertical support stage 120c among the support stages 120, and by which winch 161 the wire rope 162 is wound and unwound. The wire rope 162 is wound, at one end side, around the winch 161 and extends, at the other lower end, downward to the upper portion of the carrier 170 via the auxiliary vertical support stage 150, and is connected thereto. For smooth winding and unwinding of the wire rope 162, the auxiliary base 152 formed on the auxiliary vertical support stage 150 is preferably provided with a plurality of support rollers 153 via which the plurality of wire ropes 162 extend.

The guide rollers 163 are provided on one side of the carrier 170 to be guided along the guide rails 140 for vertical movement so as to allow the carrier 170 to stably move along the guide rails 140 for vertical movement without shaking. For example, when it is constructed such that the guide rollers 163 are provided on all around one side of the carrier 170, and the guide rail 140 for vertical movement is inserted, on its one side, between the guide rollers 163, the carrier 170 can be moved up and down along the guide rails 140 for vertical movement without being detached therefrom while it is drawn by the wire rope 162 to be wound and unwound with the driving of the winch 161.

Further, as is not illustrated in the drawings, as the lifting device 160, a rack and a pinion can be employed in such a way that for example, the rack is provided along the guide rails 140 for vertical movement, and on the side of the carrier 170, the pinion engaged with the rack, and a motor for driving the pinion are provided, which construction may have the same function as that of the above lifting device 160.

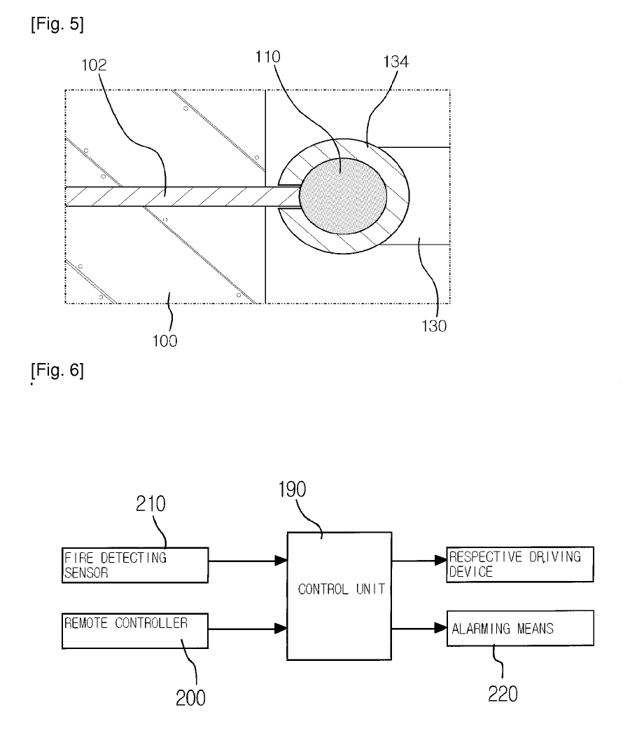

Meanwhile, as illustrated in FIG. 5, a fire detecting sensor 210 as a component of a sprinkler device is provided in the building to detect heat and smoke. The carrier 170 may be provided with a control unit 190 which upon receiving a signal from the fire detecting sensor 210, controls to drive the motor 132 for horizontal movement and the winch 161 thus to automatically move the carrier 170 to a place of fire occurrence (a place for rescuing), or manually adjust the carrier 170. As wireless communication means, a radio frequency (RF) wireless communication module may be adapted, for example.

Thus, upon fire occurrence, the motors 132 for horizontal movement and the winches 161 are driven by the control unit 190, so that the carrier 170 can automatically approach the place of fire occurrence. Further, in case of adjusting the carrier 170 in a manual control manner, a rescuer gets on the carrier 170 and controls the carrier 170 to move to the place of fire occurrence using the control unit 190, or otherwise, he/she remotely controls the carrier 170 via a remote controller 200.

Alarming means 220 may be further provided in the carrier 170, which means is operated by the control unit 190 to quickly notify a janitor or occupants of the fact of fire occurrence, thereby giving much help in rescue and initial fire-fighting. As the alarming means, for example, an alarming siren, a fire broadcasting device, an alarming lamp and others can be adapted.

In addition, fire extinguishing means may be further provided in the carrier 170, the means including for example, a fire extinguisher 230, a sprayer 240 and others. The fire extinguisher 230 is preferably a portable type that is equipped in the carrier 170. Further, the sprayer 240 may include a tank 241 provided in the carrier 170 to store extinguishant water or special extinguishant liquid therein, a pump 242 pumping the extinguishant water or special extinguishant liquid from the tank 241, and a spray nozzle 243 spraying the extinguishant water or the special extinguishant liquid from the pump 242. The sprayer 240 can be manually operated in the carrier 170 by the control unit 190, or otherwise remotely operated from outside by a remote controller 200 to be described later.

Further, an oxygen mask 250 is preferably provided in the carrier 170 to prepare for the case where the refugees got on the carrier 170 have difficulty in breathing due to flames or smoke.

Furthermore, a monitoring camera 260 is preferably further provided in the carrier 170 so as to monitor the state inside the carrier 170. In this case, a rescuer or a janitor can remotely adjust from outside the carrier 170 using images obtained from the monitoring camera 260 by the remote controller 200. That is, the rescuer or the janitor operates the remote controller 200 according to the images from the monitoring camera 260, and the operation signals are input to the control unit 190 to control the respective driving devices of the motors 132 for horizontal movement, the winches 161, the cylinder device 181 in the carrier 170, the pump 242, and others, thereby properly adjusting the carrier 170.

Meanwhile, power failure may occur in the fire escape apparatus of the invention due to fire occurrence. To prepare for this, a storage battery 270 is preferably further provided in the fire escape apparatus of the invention. The storage battery 270 may be provided in a lowermost vertical support stage 120a of the vertical support stages 120, for example. In addition, for example, an auxiliary base 271 may be further provided under the lowermost vertical support stage 120a, and the storage battery 270 and a DC power converter (not shown) may be provided on the auxiliary base 271.

Thus, even upon failure occurrence of AC power supplied from the building to the fire escape apparatus of the building, DC power from the storage battery 270, that has stood ready to operate, can be supplied to the respective driving devices of the fire escape apparatus of the building of the invention through conversion to AC power by the DC power converter, so that there occurs no problem in adjusting the carrier 170.

Meanwhile, the fire escape apparatus for a building according to the present invention may be provided on the corner side of the building so as not to impair the appearance of the building. In this case, for refugee s convenience, the fire escape apparatus is preferably installed such that it is pivoted from one outer wall 100 to the adjacent outer wall on the corner of the building.

To this end, as illustrated in FIG. 3, a telescopic cylinder device 280 is provided such that one end is connected to the corner of the building and the other end to the base 130 of the utmost vertical support stage 120c. According to this construction, with a proper combination of the drive of the motors 132 for horizontal movement and the telescopic drive of the telescopic cylinder device 280, the fire escape apparatus of the invention can be moved from one outer wall 100 to the adjacent outer wall on the corner of the building. In this case, since the driving rollers 133 are detached upon pivoting of the vertical support stages 120, the guide rails 110 for horizontal movement should have a structure that the driving rollers 133 can be engaged and disengaged. Herein, the support in the state where the driving rollers 133 being engaged is carried out by the guide rails 110 for horizontal movement and the telescopic cylinder device 280.

Next, description will be made of the operation of the fire escape apparatus for a building of the invention as constructed above.

Upon fire occurrence in the building equipped with the fire escape apparatus of the invention, the building is heated due to flames and filled with smoke. In this case, when heat and smoke are detected above a predetermined value by the fire detecting sensor 210 in the building, the detecting signals are input to the control unit 190 of the carrier 170 so that the winches 161 and the motors 132 for horizontal movement come to be driven by the control of the control unit 190.

With the drive of the motors 132 for horizontal movement, the driving rollers 133 engaged with the guide rails 110 for horizontal movement are rotatively moved to allow the vertical support stages 120 to move in a horizontal direction, and with the operation of the wire rope 162 wound and unwound by the drive of the winch 161, the carrier 170 is moved along the guide rails 140 for vertical movement of the vertical support stages 120, so that the carrier 170 can be moved to a certain position.

Thus, since the carrier 170 can be moved to a certain position on the outer wall 100 of the building, it can approach a place of fire occurrence (i.e., a place of rescuing refugees) automatically and quickly. At the same time, the fact of fire occurrence is notified to a janitor or occupants through the alarming means 220.

In the case that it is difficult for the carrier 170 to drive automatically, or the approaching position is incorrect, for example, it is possible for a rescuer to adjust the carrier 170 using the control unit 190, getting thereon, or otherwise, for a janitor to remotely adjust the carrier 170 using the remote controller 200.

When the carrier 170 reaches the rescuing position, the door 180 comes to automatically or manually open and put over the window threshold or the handrail 104 of a veranda, so that the refugees moved thereto can get on the carrier 170 through the steps 182 of the open door 180.

If a rescuer gets on the carrier 170, the rescuer can prohibit approaching of flames or initially extinguish the fire using fire extinguishing means, i.e., the fire extinguisher 230 or the sprayer 240, as well as can give help the refugees escaping and getting-on the carrier. If the refugees have difficulty in breathing, they can secure their breathing, wearing the oxygen masks by the rescuer s help or by themselves.

After the refugees are completely got on the carrier, the door 180 is closed so as not to hinder the movement of the carrier 170, the carrier 170 is moved horizontally and downward to the ground with the manipulation of the control unit 190 in the carrier 170, or the remote control via the remote controller 200 from outside, and finally the door 180 is opened to escape the refugees. Then, the above procedure is repeated with the manual adjustment of the carrier 170, so that rescuing and initial fire fighting can be quickly and safely performed until a fire department arrives at the place of fire occurrence.

As set forth before, according to the fire escape apparatus for a building of the present invention, at the start of fire occurrence, the carrier 170 can automatically or manually approach the rescuing position so that it is easy to rescue, and it is easy for a rescuer to approach the place of fire occurrence and easily carry out initial fire-fighting using the fire extinguishing means equipped in the carrier 170, thereby considerably reducing economical damage and loss of lives due to fire occurrence.

Further, the fact of fire occurrence can be initially notified to the occupants via the alarming means 220 to allow them to escape rapidly, thereby more effectively reducing loss of lives.

Furthermore, the carrier 170 can be moved to a certain position on the outer wall 100 on the corner of the building, thereby reducing the installing costs of the fire escape apparatus without a need to install many fire escape apparatuses.

Although exemplary embodiments of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICABILITY

As set forth before, according to the fire escape apparatus for a building of the present invention, at the start of fire occurrence, the carrier 170 can automatically or manually approach the rescuing position so that it is easy to rescue, and it is easy for a rescuer to approach the place of fire occurrence and easily carry out initial fire-fighting using the fire extinguishing means equipped in the carrier 170, thereby considerably reducing economical damage and loss of lives due to fire occurrence.

Further, the fact of fire occurrence can be initially notified to the occupants via the alarming means 220 to allow them to escape rapidly, thereby more effectively reducing loss of lives.

Furthermore, the carrier 170 can be moved to a certain position on the outer wall 100 on the corner of the building, thereby reducing the installing costs of the fire escape apparatus without a need to install many fire escape apparatuses.

1. A fire escape apparatus for a building comprising:
a plurality of guide rails (110) for horizontal movement provided at certain inter-floor intervals on an outer wall (100) of the building;
bases (130) coupled to the guide rails for horizontal movement to move therealong through a drive of synchronously driven motors (132) for horizontal movement;
a plurality of vertical support stages (120) vertically coupled to each other, and each having a guide rail (140) for vertical movement provided under the base; and
a carrier (170) accommodating fire-refugees therein and moving up and down a long the guide rails for vertical movement with a lifting device (160).

2. The fire escape apparatus for a building according to claim 1, wherein the lifting device (160) includes: a winch (161) provided on an utmost vertical support stage (120c) of the vertical support stages; a wire rope (162) wound and unwound with the operation of the winch and connected at its lower end to an upper portion of the carrier (170); and a plurality of guide rollers (163) provided on the side face of the carrier to roll along the guide rails (140) for vertical movement.

3. The fire escape apparatus for a building according to claim 1, wherein the carrier (170) is provided with a control unit (190) configured to, upon receiving a signal from a fire detecting sensor (210) detecting heat and smoke, drive the motors (132) for horizontal movement and the winch (161) to enable the carrier to automatically move to a place of fire occurrence, or manually control the carrier.

4. The fire escape apparatus for a building according to claim 3, wherein the carrier (170) is further provided therein with a monitoring camera (260) and a remote controller (200) for allowing a rescuer to remotely control the carrier from outside using images obtained from the monitoring camera.

5. The fire escape apparatus for a building according to claim 3 or 4, wherein the carrier (170) is further provided with alarming means (220) operated through the control unit (190) upon the fire occurrence.

6. The fire escape apparatus for a building according to claim 3 or 4, wherein the carrier (170) is provided with a door openable by a cylinder device (181), the door having steps (182) thereon.

7. The fire escape apparatus for a building according to claim 6, wherein the steps (182) are further provided with a guide lamp (183).

8. The fire escape apparatus for a building according to claim 3 or 4, wherein the carrier (170) is further provided with fire-extinguishing means for extinguishing flames.

9. The fire escape apparatus for a building according to claim 8, wherein the fire-extinguishing means is a fire-extinguisher (230) and a sprayer (240) for spraying extinguishant water or special extinguishant liquid.

10. The fire escape apparatus for a building according to claim 1, wherein the carrier (170) is provided therein with an oxygen mask (250).

11. The fire escape apparatus for a building according to claim 1 or 2, wherein a lowermost vertical support stage (120a) of the vertical support stages (120) is further provided with a storage battery (270) for upon power failure, supplying power to a driving device.

12. The fire escape apparatus for a building according to claim 1, wherein the guide rail (140) for vertical movement has a transverse section of a triangle or a rectangle.

13. The fire escape apparatus for a building according to claim 1, wherein the apparatus is further provided with a telescopic cylinder device (280) for allowing the vertical support stages (120) on the corner of the building to be pivoted from one outer wall (100) to the adjacent outer wall on the corner, the cylinder device having opposite ends wherein one end is connected to the corner side of the building and the other end to the base (130) of the utmost vertical support stage (120c) among the vertical support stages (120).
